(19) United States
(12) Patent Application Publication
(10) Pub. No.: US 2007/0189457 A1
(43) Pub. Date: Aug. 16, 2007

(54) Method for displaying a devise in a 3-D image of a volumetric data set

(76) Inventor: Frank Deinzer, Rothenbach (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/507,843

(22) Filed: Aug. 22, 2006

(30) Foreign Application Priority Data
Aug. 22, 2005 (DE) 10 2005 039 657.7

(51) Int. Cl. H05G 1/64

(52) U.S. Cl. 378/98.12

(57) ABSTRACT

The invention relates to a method and a device for displaying a device inserted into a vascular system, in particular a medical instrument, in a 3-D volumetric data set by creating 2-D fluoroscopic images of the device, wherein information is integrated recursively from consecutive 2-D fluoroscopic images of the device into previous information or previous knowledge about the 3-D positions, wherein information is determined from the 3-D volumetric data set as to which 3-D positions are plausible for the device, and that because of the information from the previous information or knowledge and the determinations, the currently possible position of the device is superimposed on the image of the 3-D volumetric data set.

### CROSS REFERENCE TO RELATED APPLICATIONS

This application claims priority of German application No. 10 2005 039 657.7 filed Aug. 22, 2005, which is incorporated by reference herein in its entirety.

### FIELD OF THE INVENTION

The invention relates to a method and a device for displaying a device inserted into a vascular system, in particular a medical instrument, in a 3-D volumetric data set by creating 2-D fluoroscopic images of the device.

### BACKGROUND OF THE INVENTION

In increasing measure, procedures carried out on patients are minimally invasive, where, for example, an x-ray control is used to guide a catheter or other medical instrument through the bloodstream to the diseased point in the body. This can be used to treat inter alia tumors, aneurisms, AVMs (arteriovenous malformations (Arterio Venous Malformatio))and stenoses for example. The navigation of the catheter from the point it enters into the body to the site of the disease presents a big challenge even for experienced medical practitioners. In this respect, navigation in the neural area stands out in particular, as targeted navigation in the filigree branching of the vascular system in the brain is extremely demanding.

The problem here is that although the catheter is clearly visible during the x-ray fluoroscopy, the anatomy of the patient, in particular his vascular structure, is, on the other hand, scarcely recognizable in the fluoroscopic image, or, as the case may be, only recognizable after a contrast medium has been injected.

Since 3-D image data sets have been increasingly employed in recent years, and are generally available, as can be seen, for example, from the U.S. Pat. No. 5,764,719 or the DE 101 46 915 B, the aim is not to just have the catheter visible only in the 2-D fluoroscopic image, but also in a 3-D data set of the patient.

The previous solutions to the problem can be divided into 2-D and 3-D visualization of the medical instrument in the vascular system.

2-D visualization of the vascular system and the catheter: It has been prior art and current practice for many years to administer the contrast medium in the vascular system area, in which, for example, a catheter is just being moved, to store a fluoroscopic image, in which the contrast medium makes the blood vessels visible, as a reference image and to place this image under the subsequent fluoroscopic imaging. A visualization of this kind is known as Roadmap Method, known, for example, from U.S. Pat. No. 4,709,385.

3-D visualization of the catheter in the vascular system: The difficulty here is that a correspondence must be created between at least one point in the 2-D fluoroscopic image (e.g. the tip of the catheter) and the 3-D data set.
If there are at least two fluoroscopic images available, whose projection directions are at an angle, then the desired 3-D position results from the intersection lines of the planes of the rear projection. A method of this kind following this approach, is described, for example, in the US 2003/0220555 A1.
Electroanatomy mapping systems, such as, for example, “Biosense Webster's CARTO™ XP EP Navigation”, use special, magnetic sensitive catheters that can be localized by external sensors, as can be seen, for example, in the manufacturer's Internet site http://www.jnjgateway.com/home.jhtml?loc=USENG&page=viewContent&contentId =09008b988008e25c&nodekey=/Prod_Info/Company/Biosense_Webster/Electrophysi ology/EP_Navigation_Systems.

### SUMMARY OF THE INVENTION

The invention is based on the task of developing a method of the type mentioned in the beginning in such a way that, from 2-D fluoroscopic images the positions of a medical instrument inserted into the vascular system of a patient can be superimposed on a 3-D image of a volumetric data set in a simple manner.

According to the invention, the task is solved in that information is integrated recursively from consecutive 2-D fluoroscopic images of the device into previous information or previous knowledge about the 3-D positions, wherein from the 3-D volumetric data set information is determined which 3-D positions are plausible for the device, and in that because of the information from the previous information or knowledge and the determinations, the currently possible position of the device is superimposed on the image of the 3-D volumetric data set. This makes it possible to determine, in a simple fashion, the spatial position of a medical instrument inserted in the vascular system of a patient from a sequence of fluoroscopic images. An exact estimation of the 3-D position only becomes possible when several 2-D images are integrated, as only in their entirety (integration) do the 2-D images contain information, which no single image, or, for the most part, any subset of these images contains.

An essential characteristic of the method is that the information from new images can be integrated without the old images having to be present, as expressed by “recursively”.

All possible catheter positions that describe its movement in its temporal sequence belong to the information or to the knowledge. This also includes the corresponding projection matrix for each position of the catheter, as it is only in this way that a relation can be established between 2-D coordinates in the image and 3-D coordinates in 3-D volumes. The presence of the projection matrices also ensures that external equipment parameters, such as C-arm angulation, zoom, table position, etc., do not have to continue to be considered separately.

2-D fluoroscopic images with same positions of the instrument also provide valuable new information: this thus makes the estimation more exact. From images of the same instrument position, it is true that many kinds of ambiguities are not resolved, but new 2-D fluoroscopic images, which, according to the invention, are produced at different positions of the instrument, are always a gain in information that improves the estimation.

It has proved to be advantageous if the determination and visualization of the 3-D coordinates of the medical instrument inserted in the vascular system is made, taking into consideration ambiguities, i.e. ambiguities with two or more possible interpretations, from a sequence of fluoroscopic images, wherein the information on the position of the medical instrument is merged over time to obtain a current estimation of the most likely 3-D positions at any given point in time.

Advantageously, the method can consist of the following steps:
a) Creation of a 3-D volumetric data set of the examination object,
b) Creation of a first fluoroscopic image,
c) 2-D/3-D registration of fluoroscopic images with the 3-D volumetric data set,
d) Estimation of the 3-D position of a medical instrument inserted into the vascular system of the examination object using a method that for each 3-D position demonstrates the security/quality of precision that the instrument is at this position,
e) Determination of possible 3-D coordinates of the medical instrument inserted into the vascular system of the examination object,
f) Visualization of the possible 3-D positions in the 3-D volumetric data set,
g) Creation of additional fluoroscopic images and repetition of the steps c) or d) to f).

The “possible 3-D coordinates” according to step e) results from the quality of all possible 3-D positions, by selecting, for example, only the n-best or those that achieve a certain minimum quality.

The jump from step g) back to step c) is only necessary if the 2-D/3-D registration is no longer valid, whereby, in principle, it does no harm always to carry out the 2-D/3-D registration.

According to the invention, as step d) it is possible to make a probalistic estimation of the 3-D position of a medical instrument inserted into the vascular system of the examination object using a density that, for each 3-D position, expresses the probability of the instrument being at this position.

It has proved to be of advantage if as first step d) after the creation of a first fluoroscopic image, the corresponding initial position in the fluoroscopic image is selected manually.

Alternatively as first step d) after the creation of a first fluoroscopic image, the corresponding initial position in the fluoroscopic image is selected using the differential image method or by identifying the corresponding initial position in the fluoroscopic image by object or pattern recognition methods.

The object is achieved for a device according to the invention in that with an x-ray diagnostic device with a detector for capturing fluoroscopic images and viewing monitors for reproducing the fluoroscopic image, the detector is linked to a mixer stage for superimposing a point determined by selection circuitry, and in that the outlet of the mixer stage is linked to one of the viewing monitors for reproducing the fluoroscopic image and is further linked to the input of a rear projection stage, to which a projection matrix of the 2-D/3-D registration is fed from a matrix storage device, and in that a stage for vascular segmentation is connected to a 3-D image storage device for a 3-D volumetric data set, and in that the rear projection stage and the stage for the vascular segmentation are linked to a device for point determination, the outlet of which is connected to a 3-D monitor from the viewing monitors.

Advantageously, the method to display a device, in particular a medical instrument, inserted into a vascular system, in a 3-D volumetric data set by creating 2-D fluoroscopic images of the device, wherein, from consecutive 2-D fluoroscopic images of the device information [lacuna] recursively into the previous information or the previous knowledge about the 3-D positions, can be defined by the following steps:
a) creation of a 3-D volumetric data set (V) of the examination object,
b) Creation of a first fluoroscopic image (fₒ),
c) 2-D/3-D registration of fluoroscopic images (fₜ) with the 3-D volumetric data set (V),
d) Estimation of the 3-D position of a medical instrument inserted into the vascular system of the examination object using a method that for each 3-D position demonstrates the security/ quality of precision that the instrument is at this position,
e) Determination of possible 3-D coordinates of the medical instrument inserted into the vascular system of the examination object,
f) Visualization of the possible 3-D positions in the 3-D volumetric data set (V),
g) Creation of additional fluoroscopic images (fₜ) and repetition of the steps C) to f) or d) to f), and in this way the current possible position of the device is superimposed on the image of the 3-D volumetric data set.

### BRIEF DESCRIPTION OF THE DRAWINGS

The invention is described below in more detail using embodiments illustrated in the drawing, in which;

FIG. 1 shows an x-ray diagnostic device,

FIG. 2 shows a part of an image system according to FIG. 1,

FIG. 3 shows a first fluoroscopic image with a catheter,

FIG. 4 shows a 3-D volumetric data set with the markings corresponding to FIG. 3,

FIG. 5 shows a second fluoroscopic image with catheter pushed further forward,

FIG. 6 shows a 3-D volumetric data set with markings belonging to FIG. 5,

FIG. 7 shows a third fluoroscopic image with catheter pushed still further forward,

FIG. 8 shows a 3-D volumetric data set with markings corresponding to FIG. 7,

FIG. 9 shows a fourth fluoroscopic image with catheter pushed further forward with a different angle of view,

FIG. 10 shows a 3-D volumetric data set with markings belonging to FIG. 9 and

FIG. 11 shows a flowchart of the inventive method.

### DETAILED DESCRIPTION OF THE INVENTION

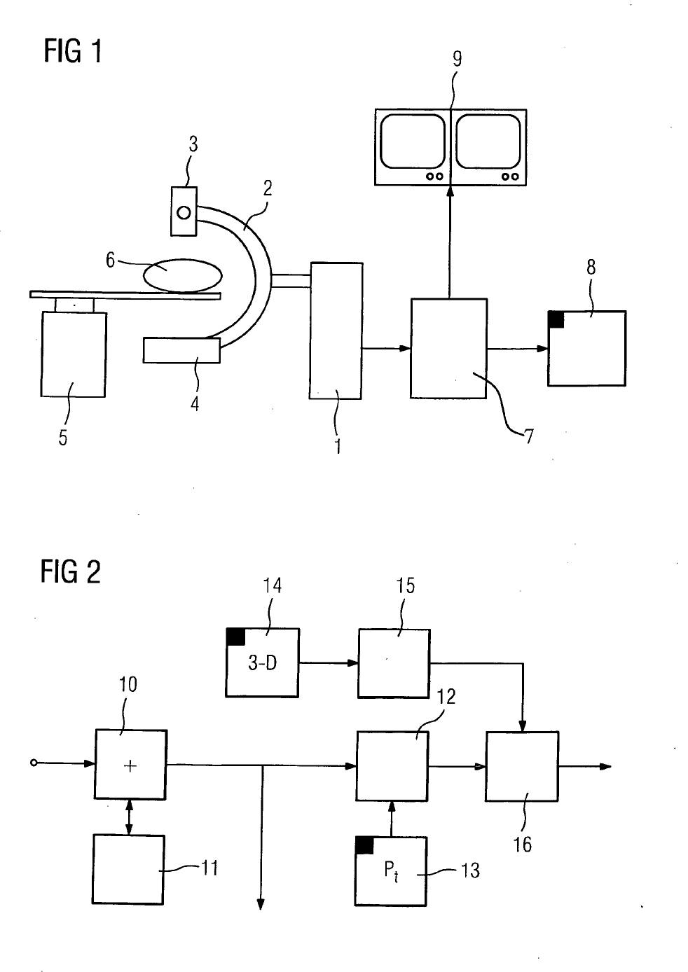

In FIG. 1 an x-ray diagnostics device is shown, said device having a C-arm 2 which can be pivoted on a stand 1, at the ends of the C-arm of which are attached an x-ray device 3 and an x-ray image detector 4.

Instead of stand 1, floor and/ or ceiling mounts can also be used. The C-arm 2 can also be replaced by a so-called electronic C-arm 2, where x-ray device 3 and x-ray image detector 4 are coupled electronically.

The x-ray image detector 4 can be a rectangular or square, flat semiconductor detector that is made preferably from amorphous silicon (aSi).

A patient 6 is placed on an examination table 5 for examination and x-rayed using the x-ray device 3, so that an attenuated signal corresponding to the radiation transparency of the patient 6 falls on the x-ray image detector 4.

The x-ray diagnostic device delivers the output signal of the x-ray image detector 4 to an image system 7 that manages the control of the x-ray diagnostic device and the further processing of the digital image signals. The digital image signals processed in this way are fed to a device for representing positions of a medical instrument inserted in a vascular system in a 3-D volumetric data set, which will be described below. A storage device 8 for a 3-D volumetric data set and a projection matrix are connected to the image system 7.

The image system 7 generates video signals in known way from the digital picture signals, which video signals can be reproduced on viewing monitors 9. Here, a fluoroscopic image can be represented on the one monitor and an image of a 3-D volumetric data set on the second.

In FIG. 2, a part of the image system 7 is reproduced. The current fluoroscopic image is fed to a mixer stage 10, in which a point fixed by a selection circuitry 11 is superimposed and which point should represent the catheter tip. This point can be identified using the selection circuitry 11, for example by manually selecting the corresponding position in the image, by differential image methods or by the object recognition or pattern recognition methods. If using the automatic recognition of the point, the point is not reproduced correctly in the fluoroscopic image, this can be corrected manually.

The output signal of mixer stage 10 is reproduced on one of the viewing monitors 9 for the fluoroscopic image. The mixer stage 10 remains connected to the input of a rear projection stage 12, to which a projection matrix Pₜ, is fed from a matrix storage device 13, which contains the 2-D/3-D registration.

The 3-D volumetric data set contained in a 3-D image storage device 14 is linked to a stage 15 for vascular segmentation, the output signal of which is fed to a device 16 for point determination, which device is linked to a 3-D monitor of the viewing monitors 9.

The matrix storage device 13 for the projection matrix Pₜ and the 3-D image storage device 14 can be contained in the storage device 8 or be separate data storage devices in the image system 7.

The method described below, according to the invention, realized in the image system 7 according to FIG. 2, enables the 3-D coordinates of the medical instrument inserted in the vascular system to be determined and visualized, allowing for ambiguities, from a sequence of fluoroscopic images that do not have to be at an angle to each other. Thereby, the information about the position of the medical instrument is merged over time to provide a current estimation of the most probable 3-D positions at any given point in time.

Determining the 3-D Coordinates

The following data and data structures are presumed:
3-D volumetric data set, consisting of voxels v_{xzy}:
   V=(v_{xyz} )
A segmentation of the vascular tree of the 3-D volumetric data set V, which provides a classification of each voxel in the classes “belonging to the vascular tree” and “not belonging to the vascular tree”:

$$seg ( {( x , y , z )}^{T} ) = \{ \begin{matrix}1 if {v}_{xyz} is a voxel of the vascular tree \\ 0 if {v}_{xyz} is not a voxel of the vascular tree\end{matrix}$$
In addition, the segmentation provides the vascular tree center lines. Methods from technical literature can be used here, such as for example is described in “Fast, interactive segmentation of medical 3D data sets using image foresting transformation in two different resolution stages” by Regina Pohle et al., which was published in the Springer-Verlag in the Information Technology Today sequence, Image Processing in Medicine 2002—Algorithms —Systems —Applications, Proceedings of the Workshop from 10th to 12th Mar. 2002 in Leipzig.
Fluoroscopic images fₜ at the points in time t with the associated parameters of the C arc equipment (e.g. CRAN/LAO-coordinates, SID, zoom, table position).
2-D/3-D registration of the fluoroscopic images fₜ, with the 3-D volumetric data set V. i.e. the projection matrix Pₜ, which maps V on fₜ, is known. To calculate these, the parameters of the C-arm system (e.g. CRAN/LAO-coordinates, SID, zoom, table position) is used.
The coordinates (x, y, z), which describe the most probable positions of the medical instrument (e.g. catheter tip) in the coordinate system of the 3-D volumetric data set, are to be determined. In formal terms, this means that a statement should be made regarding the status (corresponds, for example, to the position of the catheter tip) q=(x, y, z)^{T} of the medical instrument. Initially, before any fluoroscopic images fₜ were processed, the status is undetermined, i.e. no reliable statements can be made regarding the 3-D position e.g. of the catheter tip—all the 3-D positions are equally probable.

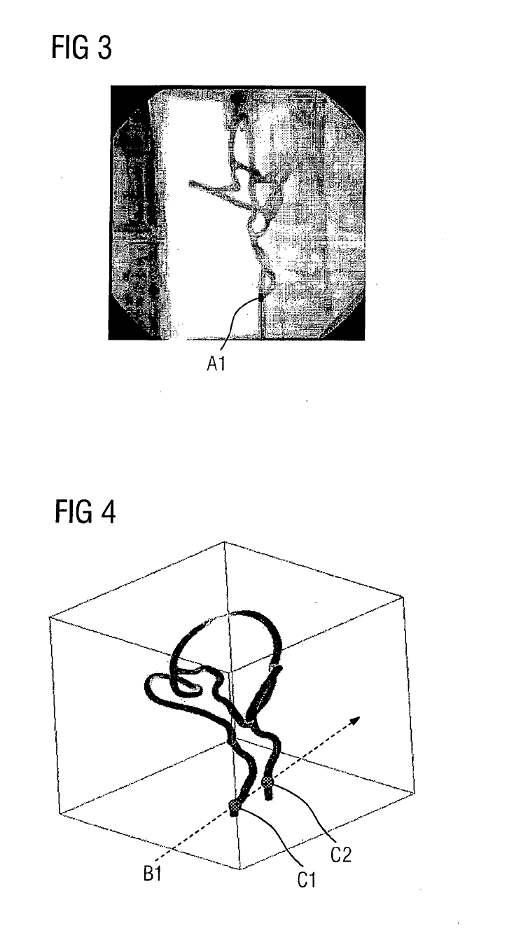

In the first fluoroscopic image f₀ (i.e. at the point in time t=0) illustrated in FIG. 3, the medical instrument is identified, for example, by manually selecting the corresponding position in the image, by differential image methods or by object recognition or pattern recognition methods by means of the selection circuitry 11. A catheter tip, as an example of a medical instrument, is marked as A1 in FIG. 3. A 2-D point is thus achieved, with the help of which one can, through rear projection using the rear projection stage 12, allowing for the known 2-D/3-D registration matrix P₀, stored in the matrix storage device 13, determine the associated line of sight through the 3-D volumetric data set by means of the device 16 for point determination. Thus the position of the catheter in the 3-D volumetric data set is limited to a straight line g₀, which corresponds to the straight line marked B1 in FIG. 4.

A more exact position determination is possible if information on the vascular system is integrated. That means that only points on g₀ that are at a sufficiently small distance from a blood vessel, as is shown by the marked points C1 and C2 in FIG. 4, are possible as the true 3-D position. It stands to reason and is clear from FIG. 4 that situations could occur in which g₀ intersects more than one blood vessel. In this case, the position cannot be determined clearly with the method used up until now, as the ambiguities that arise cannot be solved. What, however, can be calculated in any case is a density over the state (of the 3-D position) of the medical instrument:

$$p ( {q}_{0} \text{\vert} {g}_{0} ) = seg ( {q}_{0} ) \cdot d ( {\underbrace{{q}_{0} - {arg min}_{{( x , y , z )}^{T} ∈ {g}_{0}} ‖ {q}_{0} - {g}_{0} ‖}}_{distance vector} ) \qquad ( 1 )$$

Thus for every voxel of the 3-D volumetric data set, a probability can be stated that this voxel represents the true 3-D position of the medical instrument. There the above formula is a way of calculating this probability: for a specific state q₀, look for the voxel on the line of sight g₀, which has a minimal distance and calculate using a suitable statistical model d ( . . ) the probability that this state describes the true 3-D position allowing for the distance vector.

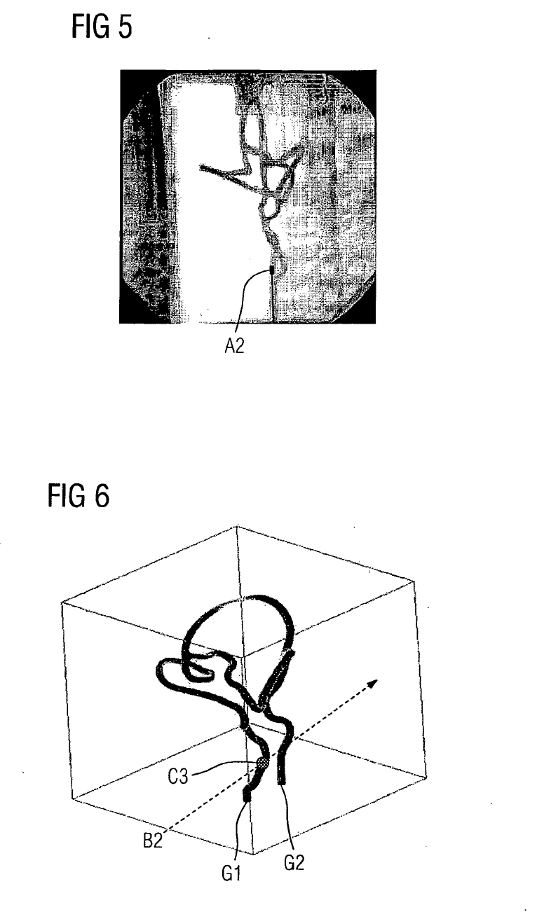

If one integrates the findings of the chronologically consecutive fluoroscopic images into these densities, then existing ambiguities can be resolved over time. With the help of FIGS. 5 and 6, the idea is easy to explain: With the fluoroscopy it will not be possible to decide whether the medical instrument is in blood vessel G1 or G2, until a line of sight no longer runs through the two competing blood vessels. By means of this procedure, existing ambiguities in the determination of the 3-D position are successively resolved. In FIG. 5, this is possible in the fluoroscopic image at the marked position A2, which corresponds in the volume to the line of sight B2 in FIG. 6, which line of sight only intersects the vascular tree in one blood vessel, as the marked point C3 shows.

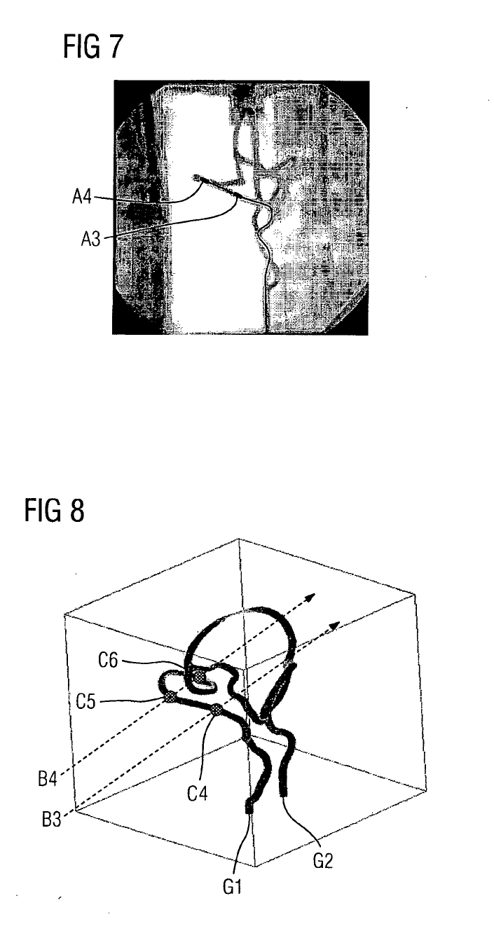

By allowing for the context, i.e. the existing information about the 3-D positions, new ambiguities arise not because when there is an unequivocal 3-D position at the point in time t-1, at the subsequent point in time t the line of sight gₜ suddenly runs through two blood vessels. This is achieved because information as to how probable it is that this is achieved in the vascular tree taking the 3-D position at the point in time t-1 as starting point, flows into the calculation of the probability of a 3-D position at the point in time t. To explain clearly, this means: is it possible to push the catheter from the 3-D position t-1 to the 3-D position t in the given space of time? With the help of the illustrations in FIGS. 7 and 8, that means that at the point in time t-1, the 3-D position of the point A3 was unequivocally determined by the line of sight B3 as C4. At the point in time t, the line of sight B4, which belongs to A4, intersects the vascular system both in C5 and also in C6, because of the context, C6 is not possible, as the path from C4 to C6 along the blood vessel is too far for the given time span between t-1 and t (“No doctor moves a catheter with the speed that would have been required here”). The calculation of the “path along the blood vessels” is based on the known vascular tree center lines (see above).

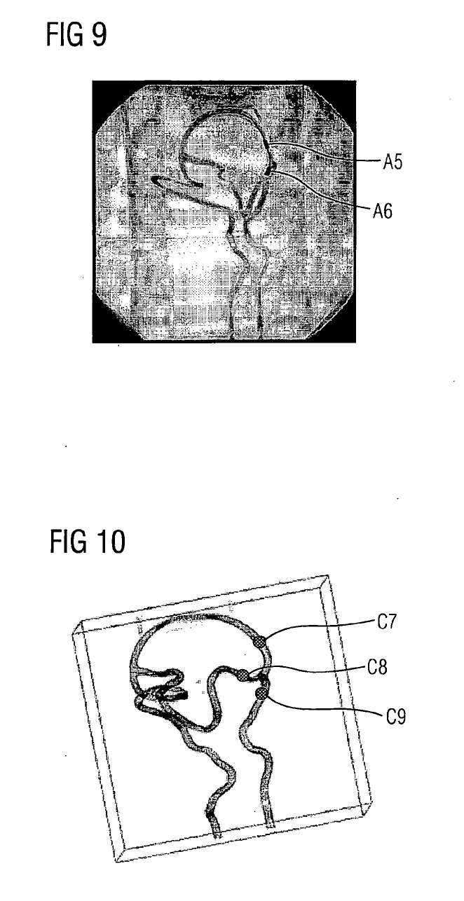

New ambiguities only arise if a blood vessel divides into at least two branches, and the line of sight intersects both branches. In FIGS. 9 and 10 this effect will occur at the step from A5 to A6. The position C7 was determined for A5. Both C8 and also C9, which are both congruent in the fluoroscopic image and which are equally possible because of the context, can belong to A6 (The distance from C7 to C8 is approximately as long as from C7 to C9). These ambiguities disappear again when future information is taken into consideration (see above).

In formal terms, this means that

$$p ( {q}_{t} \text{\vert} {g}_{t} , {g}_{t - 1} , … , {g}_{0} ) = {\underbrace{p ( {q}_{t} \text{\vert} {g}_{t} )}}_{according to ( 3 )} \cdot \cdot {\int }_{{q}_{t - 1}} {\underbrace{p ( {q}_{t} \text{\vert} {q}_{t - 1} )}}_{state transition} \cdot {\underbrace{p ( {q}_{t - 1} \text{\vert} {g}_{t - 1} , {g}_{t - 2} , … , {g}_{0} )}}_{recursive component} ⅆ {q}_{t - 1} \qquad ( 2 )$$

must be calculated, whereby the probability of a state at the point in time t results analogously from equation (1).

$$p ( {q}_{t} \text{\vert} {g}_{t} ) = seg ( {q}_{t} ) \cdot d ( {q}_{t} - {arg min}_{{( x , y , z )}^{T} ∈ {g}_{t}} ‖ {q}_{t} - {g}_{t} ‖ ) \qquad ( 3 )$$

The “state transition” in equation (2) is in that case the context component described and is calculated from the length of the path from the 3-D position qₜ₋₁ to qₜ along the blood vessel center lines. If there is no link between qₜ₋₁ and qₜ, then the distance is infinite and thus p (qₜ|qₜ₋₁) practically 0.

The “recursive component” is the knowledge about the 3-D position that was available at the point in time t-1. This was also calculated according to equation (2). In the end, the equation (2) reduces recursively until the point in time t=0 has been reached. The system is initialized with equation (1) in this initial point in time.

Non-probabilistic modelings in terms of an optimization problem can also be realized for equations (1) to (3). Therefore, the method does not depend on the mathematical formulation but on the fact that one integrates new information recursively into the previous knowledge about the 3-D position and at the same time allows information to flow in regarding which 3-D positions are at all plausible, as was explained using the example according to FIGS. 9 and 10.

Visualization of the 3-D Position

In the 3-D volumetric data set, each connected area whose probability exceeds a certain threshold value according to equation (2) is suitably highlighted or one takes, for example, the n-best 3-D points. Thereby, the 3-D volumetric data set can either be represented together with a reconstructed visualization of the medical instrument, or color or graphics are used to highlight the corresponding areas. The representation of the points C1 to C9 using circles is a very simple graphic representation possibility. Other kinds of visualization are also possible.

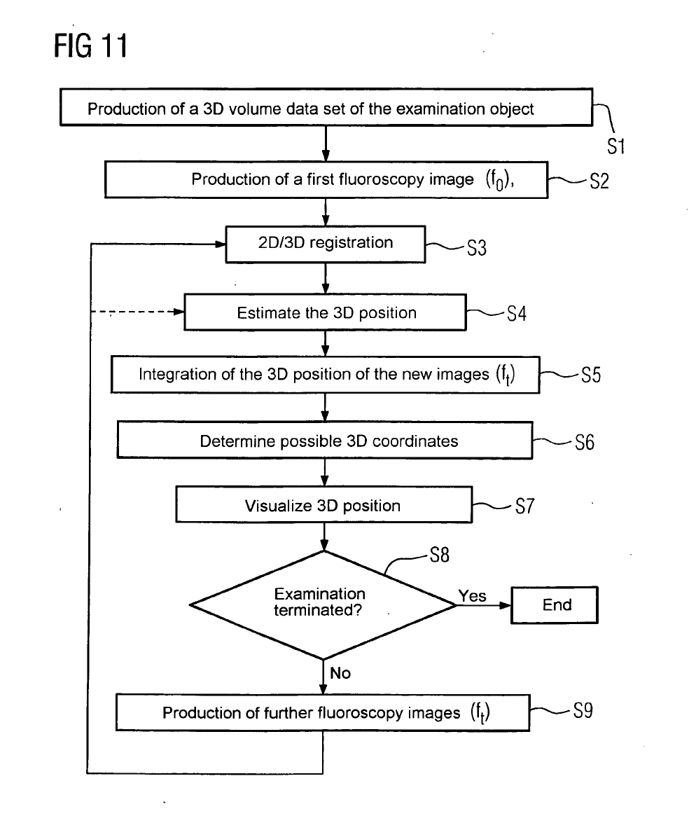

In summary the method is essentially characterized by the following procedure steps described using FIG.11:
S1 In a first procedure step, a 3-D volumetric data set of the object to be examined is created first of all. This volumetric data set can then, for example, be stored in the 3-D image storage device 14.
S2 In the second procedure step, a first fluoroscopic image f₀ is produced and fed into the image system 7.
S3 This fluoroscopic image f₀ passes through a 2-D/3-D registration in a third procedure step, which can be carried out with the 3-D volumetric data set via the projection matrix Pt that is contained in the matrix storage device 13.
S4 Subsequently, in a fourth procedure step the 3-D positions are estimated and
S5 in the fifth procedure step, the 3-D positions of the new images are integrated recursively.
S6 In the next procedure step, the possible 3-D coordinates of the catheter or of another medical instrument are determined.
S7 In the subsequent procedure step, all possible 3-D positions are visualized in the volumetric data set.
S8 If the examination is not yet completed, which fact is established by the query in the eighth procedure step,
S9 further fluoroscopic images are created in a next procedure step (S9). Subsequently one can return to procedure step S3 or S4.

The inventive method produces the advantages stated below:
A real 3-D visualization of the position of the medical instrument in the vascular tree is represented. Many previous solutions always place just an artificial projection of the 3-D volumetric data set under the current fluoroscopic image; the actual navigation is still carried out in 2-D.
Because the real 3-D position is known, the navigation is greatly simplified: the 3-D volumetric data set can be rotated, moved etc. at will. There is no need for any correlation between the direction of projection of the current fluoroscopic image and of the 3-D volumetric data set. Thus the volumetric data set can be visualized from positions and directions that the C arc equipment cannot achieve. Comparable results can only be achieved today from systems such as “Biosense Webster's CARTO™ XP EP Navigation”, by using additional, complex and expensive technology.
The solution presented works purely image based—there is no necessity of fluoroscopic images that have to be at an angle—no triangulations are necessary. Up until now the executing medical practitioner had to take fluoroscopic images from different directions in order to be able to use this to make a one-time determination of a 3-D position. In contrast, the solution presented integrates the context of fluoroscopic sequences fully automatically—this thus continuously provides an estimated 3-D position, without the medical practitoner having to interrupt his workflow.
The solution presented automatically solves the ambiguities that can arise. Any number of ambiguities can be dealt with. All possible 3-D positions are “drawn in” over time.
It is not necessary to store fluoroscopic images or other data from all previous time bins. For the method suffices that the estimated 3-D positions of the last time bin is available. As soon as these are processed and integrated into the current 3-D position estimation, they can be deleted.
The intelligent use of knowledge about which 3-D positions are plausible in the context of the existing information on the 3-D position (->blood vessel center lines), is a further feature of this method that stands out.

The essential in the method according to the invention is that the 3D position of the medical instrument is determined
from x-ray images that do not have to be at an angle to each other (but can do so). If one had at least two images that are at an angle to each other, then the 3D position determination can be done very easily using the triangulation method. If, however, one has images that are not at an angle to each other, then all information on depth is lacking. The registration carried out by us serves to enable a 2D point in the image to be assigned to each 3D point in the 3D data set. Conversely, one can plot a straight line through the 3D data set from the registration for each 2D point in the image, (i.e. the 2D point lies somewhere on this straight line—there the missing information on depth shows clearly). The 3D position determination per optical or magnetic tracking system is a relatively simple problem. Just as is the 3D position determination if the images are at an angle. Our situation is difficult where the images are not at an angle.
We solve this dilemma of the missing depth using chronological information from the 3D data set, a sequence of images. This context means that our medical instrument, a catheter, is inside a blood vessel - these blood vessels can be determined from the 3D data set (e.g. 3D Angio, CTA, . . . )

Thereby recursive information means the chronological component. After a sequence of images has been created, recursive means that one integrates the information from the latest image into the previous knowledge of the position of the instrument. The advantage thereby is that with the “recursive approach” all that is required is the previous knowledge about the position and the current image. If no recursive information were used, then all the previous images would have to be stored. Then when a new image is available, said image would have to be used together with all the old images for determining the position. This approach is not practicable due to the memory requirements and the fact that the complexity of the computation increases with the number of images. With the recursive approach is ensured that a Markov process is modeled. That means that only our previous results (knowledge about the 3D position) are required and the new observations (new image with, for example, tip of the catheter located). All previous, old images are no longer required.

Furthermore, “plausible 3D positions” refer to the context information. Since all information on depth is missing from the images that are (never) at an angle to each other, which information also cannot be gained through the chronological components, information about depth must stem principally from another source. That is defmed by the “plausible 3D position”. Thereby it is assumed that the appliance is in a vessel. That means that one knows that for a point of the 2D image which shows the instrument, the only possible positions are those that are on the straight line and intersect a blood vessel. That means that of all the possible 3D positions on the straight line, only those that are within a blood vessel are plausible.

If one looks only at the context information in one single image, a large number of ambiguities will occur, as the straight line may possibly intersect many different blood vessels. If one looks only at the chronological sequence of images (without context information) then the depth is missing. Not until one combines both is a good 3D position estimation provided over time.

1-10. (canceled)

11. A method for displaying a medical device inserted into a vascular system of a patient in a 3-D volumetric data set, comprising:
creating a plurality of consecutive 2-D fluoroscopic images of the patient containing the medical device;
recursively integrating an information from the consecutive 2-D fluoroscopic images of the medical device into a previous information about a 3-D position of the medical device;
determining a currently possible 3-D position of the medical device from the 3-D volumetric data set if the currently possible 3-D position of the medical device is plausible for the medical device based on the integrated information;
superimposing the currently possible 3-D position of the medical device on an image of the 3-D volumetric data set; and
displaying the image comprising the current 3-D position of the medical device.

12. The method as claimed in claim 11, wherein the information comprises a plurality of possible medical device positions describing a movement of the medical device in a temporal sequence and a projection matrix comprising registrations of the 2-D fluoroscopic images with the 3-D volumetric data set.

13. The method as claimed in claim 11, wherein the medical device is a catheter.

14. The method as claimed in claim 11, wherein the 2-D fluoroscopic images are created with a medical instrument in different positions.

15. The method as claimed in claim 14, wherein the medical instrument is a C-arm x-ray system.

16. The method as claimed in claim 11, wherein the 3-D position of the medical device is determined from a temporal sequence of the 2-D fluoroscopic images wherein the information about the 3-D position of the medical device is merged over time to obtain an estimation of a most probable 3-D position at a given time.

17. The method as claimed in claim 16, wherein a process of the determination comprises an ambiguity of the 3-D position of the medical device.

18. The method as claimed in claim 11, wherein the method comprises steps of:
creating the 3-D volumetric data set of the patient containing the vascular system,
creating a 2-D fluoroscopic image of the patient containing the medical device,
registering the 2-D fluoroscopic image with the 3-D volumetric data set,
estimating all possible 3-D positions of the medical device inserted into the vascular system of the patient based on the registration,
recursively integrating the all possible 3-D positions into the previous 3-D position,
determining the current possible 3-D position of the medical device based on the integration to demonstrate a security and quality of precision for the current possible 3-D position, and
superimposing the current possible 3-D position in the 3-D volumetric data set.

19. The method as claimed in claim 18, wherein a further fluoroscopic image is created and the steps of registering, estimating, integrating, determining, and displaying are repeated.

20. The method as claimed in claim 18, wherein a further fluoroscopic image is created and the steps of estimating, integrating, determining, and displaying are repeated.

21. The method as claimed in claim 18, wherein the 3-D position of the medical device is estimated by a density of a probability of the medical device at the position.

22. The method as claimed in claim 18, wherein an initial position of the medical device in the fluoroscopic image is manually selected from a first fluoroscopic image of the consecutive 2-D fluoroscopic images.

23. The method as claimed in claim 18, wherein an initial position of the medical device in the fluoroscopic image is selected using a differential image method from a first fluoroscopic image of the consecutive 2-D fluoroscopic images.

24. The method as claimed in claim 18, wherein an initial position of the medical device in the fluoroscopic image is selected using an object recognition or pattern recognition methods from a first fluoroscopic image of the consecutive 2-D fluoroscopic images.

25. An x-ray diagnostic device which displays a medical device inserted into a vascular system of a patient in a 3-D volumetric data set, comprising:
an x-ray detector which captures a 2-D fluoroscopic image of the patient containing the medical device;
a mixer linked to the detector which receives the 2-D fluoroscopic image;
a selection circuitry linked to the mixer which identifies a point of the medical device and wherein the point is superimposed into the 2-D fluoroscopic image in the mixer;
a first monitor linked to the mixer which displays the superimposed 2-D fluoroscopic image;
a matrix storage device which stores a projection matrix of a registration of the 2-D fluoroscopic image with the 3-D volumetric data set;
a rear projection device linked to the mixer and the matrix storage device which receives the 2-D fluoroscopic image and the projection matrix;
a 3-D image storage device which stores the 3-D volumetric data set;
a segmentation device linked to the 3-D storage device which segments the vascular system of the 3-D volumetric data se;
a calculation device linked to the rear projection stage and the segmentation device which determines a 3-D position of the point of the medical device; and
a second monitor which displays a 3-D image of the 3-D volumetric data set comprising the determined 3-D position of the medical device.

26. The x-ray diagnostic device as claimed in claim 25, wherein the point of the medical device is a tip of a catheter inserted into the vascular system of the patient.

27. A method for displaying a medical device inserted into a vascular system of a patient in a 3-D volumetric data, comprising:
creating a 3-D volumetric data set of the patient containing the vascular system;
creating a 2-D fluoroscopic image of the patient containing the medical device;
registering the 2-D fluoroscopic image with the 3-D volumetric data set;
estimating all possible 3-D positions of the medical device inserted into the vascular system of the patient based on the registration;
recursively integrating the all possible 3-D positions into a previous 3-D position of the medical device;
determining a current possible 3-D position of the medical device based on the integration to demonstrate a security and quality of precision for the current possible 3-D position;
superimposing the current possible 3-D position of the medical device on an image of the 3-D volumetric data set; and
displaying the image comprising the current possible 3-D position of the medical device.

28. The method as claimed in claim 27, wherein a plurality of consecutive fluoroscopic images are created and the steps of registering, estimating, integrating, determining, and displaying are repeated.

29. The method as claimed in claim 27, wherein a plurality of consecutive fluoroscopic images are created and the steps of estimating, integrating, determining, and displaying are repeated.
